(19) United States
(12) Patent Application Publication
(10) Pub. No.: US 2010/0285435 A1
(43) Pub. Date: Nov. 11, 2010

(54) METHOD AND APPARATUS FOR COMPLETION OF KEYBOARD ENTRY

(76) Inventors: Gregory Keim, Broadway, VA (US); Jack August Marmorstein, Harrisonburg, VA (US); Bryan Pellom, Erie, CO (US); James Digges La Touche, Boulder, CO (US)

Correspondence Address: Kaplan Gilman & Pergament LLP, 1480 Route 9 North, Woodbridge, NJ, 07095, US

(21) Appl. No.: 12/436,268

(22) Filed: May 6, 2009

(51) Int. Cl. G09B 19/06; G06F 17/21; G09B 5/06

(52) U.S. Cl. 434/157; 715/261; 434/169

(57) ABSTRACT

A teaching machine generates a list of likely completions of an incomplete typed word, based upon previous keyboard input. This may include not only the incompletely typed word, but a number of completely typed, preceding words, in order have the word completion based upon context. The incompletely typed word is then subjected to a phonetic transcription, or other tests based upon knowledge by the system of the user, to further narrow the prediction list.

### BACKGROUND OF THE INVENTION

The present invention relates generally to teaching machines and, more particularly, concerns a method and apparatus for completion of keyboard entry by a student into the teaching machine. Additionally, the method may be applied to audio or other input as well.

Today, language teaching machines are frequently in the form of a personal computer running an appropriate program. Most frequently, the student interfaces with the computer by means of a keyboard, whereby the student may input responses in after reviewing images, studying questions, etc. If the student is just starting to learn the language, typing is slow, and if the keyboard in the new language is unfamiliar, typing is even slower. Speedy typing is essential to maintaining the student's attention and to allow effective communication and interest. This is particularly so in web-based language learning, where users attempting to learn a language may communicate textually; i.e., by typing messages to each other.

Instead of typing slowly, the student could be allowed to type quickly but inaccurately. This could result in a number of different types of errors: wholesale misspellings; incorrect inflections; incorrect word order; and incorrect word choice. Most likely, there would be a combination of errors. With such complex combinations of errors, detection and correction of errors becomes complex and time consuming, slowing down the learning process. Ideally, it would be desirable to have suggested completions of keystroke in a keystroke-saving fashion, while still allowing the student the freedom to say what he wants.

A simple solution would be to provide the student, as he types, with a selection of all the words he knows that match his keyboard entry to that point. Although this speeds up the of keyboard entry, it assumes that the first few letters of the word have been correctly entered.

In a language learning program, for example, the foregoing assumption may be wrong in one or more somewhat predictable manners. For example, the student may have begun the typing of a misspelling that sounds similar to the proper word. Or, the student may have begun typing a word that represents a synonym for the word the language program expects. This would be the case, for example, if the student has already studied more than one word that describes an image that the language learning program depicts.

There is therefore a need for a keyboard input completion system that can address all of the common types of errors.

### SUMMARY OF THE INVENTION

In accordance with one aspect of the present invention, a teaching machine generates a list of likely completions of an incompletely typed word based upon previous keyboard input. This may include not only the incompletely typed word, but a number of completely typed, preceding words, in order to have the word completion based upon context. The incompletely typed word is then subjected to a phonetic transcription, which is then compared phonetically to words in the list of likely completions, and the phonetically closest words are selected for plausible prediction list. To further narrow the prediction list, or to improve its accuracy, the words on the list may be compared to the incompletely typed word and selected or ordered based upon their orthographic closeness (how close they are in spelling).

It is a feature of one aspect of the present invention that a word being input is compared phonetically, or by definition, with potential values for that word to arrive at an estimate for the word.

It is another feature of the invention that the prediction list may also be based upon an image being displayed, or a lesson being taught, so that the system estimates what is likely being typed based upon what is most likely to be typed given the lesson being conducted.

It is a feature of another aspect of the present invention that potential values for a word being input are determined based upon their statistical likelihood in view of a predetermined number of complete words input previously. The technique is not limited to words that begin with the same spelling typed, but may be expanded to include words that sound similar or words that might be confused by the language learner with those typed because of a similar meaning.

It is another aspect of the invention that the word list of possible completed words may be based upon any one or more of the foregoing in combinations. The invention operates somewhat like an “autofill” in modem day email programs, but does not limit itself to only completing words that have had their first few letters correctly typed.

### BRIEF DESCRIPTION OF THE DRAWINGS

The foregoing brief description and further objects, features and advantages of the present invention will be understood more completely from the following detailed of presently preferred, but nonetheless illustrative, embodiments in accordance with the present invention, with reference being had to the accompanying drawings, in which:

FIG. 1 is a schematic block diagram illustrating a teaching machine 10 embodying the present invention;

FIG. 2 is a functional block diagram of an auto-completion module embodying the present invention; and

FIG. 3 is a flow chart illustrating a method for using an auto-completion module in accordance with the present invention to improve communication.

### DETAILED DESCRIPTION OF THE PREFERRED EMBODIMENTS

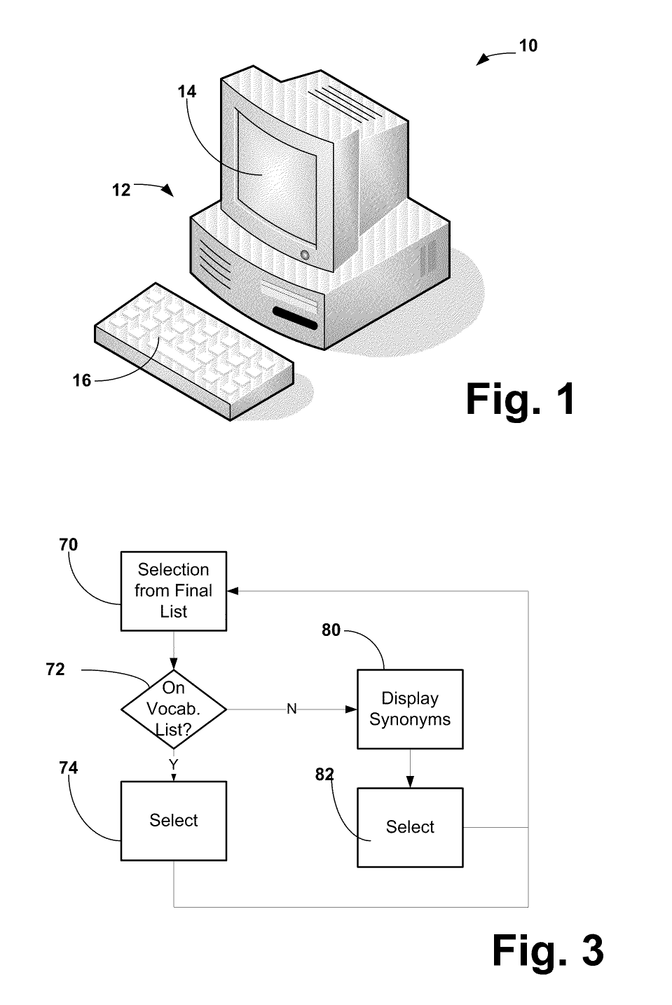

Turning now to the drawings, FIG. 1 is a schematic block diagram illustrating a teaching machine 10 embodying the present invention. Machine 10 comprises a computer 12 having a display 14 and a keyboard 16. Computer 12 is programmed to teach a foreign language. It communicates with an operator, a language student, via the display 14 and audibly, and the operator communicates with the computer via the keyboard 16 and presumably with a pointing device, such as a mouse (not shown). Typically, machine 10 would also include a microphone (not shown), for example, to allow the student to practice speaking the language while supervised by the computer.

The student's primary means for communicating with computer 12 is the keyboard 16, on which he must type quickly in order to learn efficiently and to maintain his interest in the program. Computer 12 includes an auto-completion module, which completes the typing of words while they are being entered on the keyboard or offers a choice of completed words while a word is being typed. However, as noted above, the potential choices are not selected, as in some prior systems, by simply displaying words that begin with the same few first letters as those typed.

Preferably, the auto-completion module contains an n-gram model of the language being studied. An n-gram model statistically predicts the next element of a sequence, based upon a number of sequence elements before it. Thus, an n-gram model could be used to predict directly the next key press of a typed sequence, based upon those that preceded it. However, in the preferred embodiment, the n-gram model involves words. That is, given a sequence of completed words, it will predict the next word or provide an ordered list of the words most likely to be next. Hence, the next word is predicted, at least in part contextually.

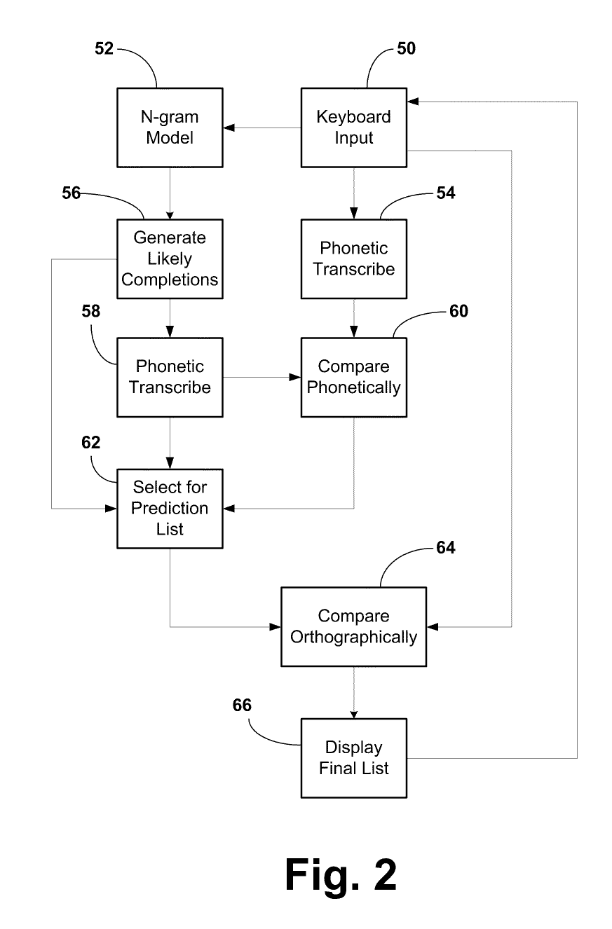

FIG. 2 is a functional block diagram of an auto-completion module embodying the present invention. Keyboard input 50 by the student (may be a partial word at this point in time) is provided to the n-gram model 52 and to a phonetic transcription device 54. N-gram model 52 continuously generates a likely completion list (block 56), based upon the preceding i completed words. The completion list is simply a list of likely completions for the current (partial) keyboard input word, the words of the completion list being in the order of likelihood.

The completion list is then subjected to a phonetic transcription 58, and the beginnings of the phonetic versions of the completion list words are compared to the phonetic transcription of the keyboard input (block 60). This comparison is preferably a qualifying step, eliminating words on the completion list that do not meet a threshold of phonetic comparison, to produce a prediction list (block 62). However, it may also be a weighting step, adjusting the order of words on a completion list based upon how closely they compare phonetically with the keyboard input. The prediction list could then be generated by simply selecting the top j words on the weighted list.

At this point, the prediction list could be displayed to the student as the final display, permitting him to make the final selection. Alternately, the top word on the prediction list could be suggested to the student. However, it is preferred that a further a level of qualification be added to the auto completion model. At block 64, the words in the prediction list are compared orthographically (for spelling) to the keyboard input. This comparison is preferably a qualifying step, eliminating words on the prediction list that do not meet a threshold of orthographic comparison, to produce and display a final list (block 66). However, it may also be a weighting step, adjusting the order of words in the prediction list based upon how closely they compare orthographically with the keyboard input. The final list could then be generated by simply selecting the top k words on the newly weighted list. Alternatively, the top word on the final list could be suggested to the student.

In addition to the foregoing, the system may also further filter (or order) the prediction list based upon the lesson being executed. For example, consider that a language learning lesson being executed includes plural images wherein the user is instructed to type a word or phrase in response to the display of images. From the first few letters typed, the system may estimate the most likely words that would correspond to a proper answer in response to the lesson, and weight such proper words. The weighting can be as simple as placing such words towards the top of the display list, or can also involve displaying only such words and eliminating others. Notably, the suggested completions can be either independent of, or not exclusively dependent upon, the first few letters entered by the user.

For example, suppose the system displays a lesson in the form of images, and then asks a question “How many apples are there in the picture?” and the expected answer is one. If the user studying Spanish begins typing U-M, the system would know to complete this as UNO, even though the user mistakenly typed an M instead of an N. Additionally, such error by the student could be logged and accounted for in planning future lessons, so that the system knows the user had word for 1 misspelled, or misunderstood.

In another example of the use of context, the typing of “The boy is eed . . . ” might trigger the system to suggest “The boy is eating . . . ,” particularly if the image is such that the system is expecting any answer stating that the boy is eating.

In still another alternative, the display list may be narrowed by filtering it through the set of words that learner already knows. In a language learning program, the system can keep track of which words have already been studied by the learner, and weight the list, either by ordering or otherwise, so that the student's past lessons are used as a guide to what word he might be typing.

After display of the final list, operation returns the block 50 to await further keyboard input.

Those skilled in the art will appreciate that the order of the phonetic comparison and spelling comparison can be reversed while still obtaining beneficial results. Additionally, when any number of plural items are accounted for in compiling the final display list, such items may be combined in many orders or weighted by different amounts.

In one enhanced embodiment, the system runs each partially typed word through a phonetic transcription, and thus ascertains the word the user may be attempting to type, even if spelled wrong. Then, phonetically close words are suggested for completion.

To determine phonetically “close words, a modified version of the Levenshtein algorithm is used. The method of Levenshtein typically returns a list of potential candidates, and then any criteria of the designer's choice can be used to pick the “best” word.

In addition to being a teaching tool, it is contemplated that an auto-completion module in accordance with the present invention could represent a valuable interface between individuals having different levels of proficiency in a language, in order to improve communication. FIG. 3 is a flow chart illustrating a method for using an auto-completion module in accordance with the present invention to improve communication. For example, suppose an advanced English speaker were carrying on a written, online, communication, in English, with a Japanese individual having limited ability in English. The English speaker's computer contains an auto-completion module and an English grade for the Japanese individual representing the proficiency level of his English.

When the English speaker selects a word from the final list (block 70), the auto-completion module performs a test (block 77) to determine whether that word is in the Japanese individual's vocabulary list (based upon his grade). If it is, that word is selected for inclusion in the communication (block 79), and control returns block 70 to await the next selection by the English speaker from a final list.

Should the test at block 77 reveal that the word selected by the English speaker is not in the Japanese individual's vocabulary list, a list is displayed showing synonyms which are in the Japanese individual's vocabulary (block 80). Upon the English speaker's selection of one of those words, the selected word is inserted into the communication (block 82), and control returns to block 70 to await the English speaker's next selection from a final list.

As an example, suppose the advanced English speaker begins to type “rapi” and the auto-completion module determines that “rapid” and “rapidly” is not on the Japanese individual's vocabulary list. It might display the synonyms “quick” and “quickly”, which are on the vocabulary list and, upon the English speaker's acceptance of a word insert it into the communication. This is particularly useful in Internet based language learning, wherein the learning program would know the lesson history of the Japanese user, and would have a relatively good record of the English words with which the Japanese learner is familiar.

In this manner, the English speaker is able to communicate with the Japanese individual in a manner which is far more likely to be understood by the Japanese individual. Although this is a very simple example, those skilled in the art will appreciate that an auto-completion module in accordance with the present invention also offers the possibility of presenting communications that would be more likely to be understood contextually by the Japanese individual.

The foregoing “leveling” technique can be used in conjunction with a speech recognition engine as well. Specifically, any of the many speech recognition algorithms commercially available can be used to recognize a speaker's words and then “level” the words by suggesting other words in the vocabulary of the language learner, using any of the techniques described above.

In still another example of leveling, the leveling is not done on the individual word level, but with respect to grammar, phrases, etc. Hence, phrases or proper forms that the user knows may be substituted to bring the verbiage “down” to the proper level.

Although preferred embodiments of the invention have been disclosed for illustrative purposes, those skilled in the will appreciate that many editions, modifications, and substitutions are possible without departing from the scope and spirit of the invention as defined by the accompanying claims.

What is claimed:

1. A method for generating an estimated value of a word while it is being input into a machine, comprising the steps of:
based upon prior input, generating likely values for the word being input;
comparing an entered portion of the word being input with likely values for an intended full word; and
selecting from among the likely values, a subset of prediction values of the word, based upon the degree of comparison in the comparing step.

2. The method of claim 1 wherein said likely values are determined based at least upon phonetic pronunciation.

3. The method of claim 1 further comprising the step of:
comparing the spelling of any entered portion of the word being input with the spelling of likely words; and
selecting from the subset of prediction values of the word a subset of final values of the word, based upon the degree of comparison in the spelling comparing step.

4. The method of claim 1 wherein the generating step is performed with the aid of a statistical model determining the likelihood of the value of the word being entered to the values of a predetermined number of previously entered complete words, whereby, the value of the estimated value is related to the context of the word being input.

5. The method of claim 4, wherein the statistical model is an n-gram model.

6. In a method for generating an estimated value of a word while it is being input into a machine, the value of the word being estimated from among a plurality of likely values of the word, the step of comparing a phoneticized version of the any entered portion of the word being input with phoneticized versions of the likely values.

7. The method of claim 6, further comprising selecting among likely values based upon the degree of the comparison.

8. The method of claim 6 further comprising the step of:
comparing the spelling of any entered portion of the word being input with the spelling of likely values; and
selecting from among likely values of the word a subset of final values of the word, based upon the degree of comparison in the spelling comparing step.

9. In a method for generating an estimated value of a word while it is being input into a machine, the value of the word to be estimated from among a plurality of likely values of the word, the step of generating a likely value of the word with the aid of a statistical model making use of the values of a predetermined number of previously entered complete words, whereby, the estimated value is related to the context of the word being input.

10. The method of claim 9, wherein the statistical model is an n-gram model.

11. The method of claim 9 further comprising the step of:
comparing the spelling of any entered portion of the word being input with the spelling of likely values; and
selecting from among likely values of the word a subset of final values of the word, based upon the degree of comparison in the spelling comparing step.

12. Apparatus for generating an estimated value of a word while it is being input into a machine, comprising:
a word generator generating likely values for the word being input based upon prior input
a first comparator of phoneticized versions of the any entered portion of the word being input with phoneticized versions of the likely values; and
a first selector responsive to a result of the first comparator for selecting from among the likely values, a subset of prediction values of the word.

13. The apparatus of claim 12 provided in a computerized teaching machine.

14. The apparatus of claim 12 further comprising:
a second comparator comparing the spelling of any entered portion of the word being input with the spelling of likely words; and
a second selector responsive to the result of the second comparator for selecting from the subset of prediction values of the word a subset of final values of the word.

15. The apparatus of claim 12 wherein the generator incorporates a statistical model determining the likelihood of the value of the word being entered to the values of a predetermined number of previously entered complete words, whereby, the value of the estimated value is related to the context of the word being input.

16. The apparatus of claim 15, wherein the statistical model is an n-gram model.

17. In an apparatus for generating an estimated value of a word while it is being input into a machine, the value of the word being estimated from among a plurality of likely values of the word, a comparator of a phoneticized version of the any entered portion of the word being input with phoneticized versions of the likely values.

18. The apparatus of claim 17, further comprising a selector selecting among likely values based upon the comparator result.

19. The apparatus of claim 18, further comprising:
a second comparator comparing the spelling of any entered portion of the word being input with the spelling of likely values; and
a second selector selecting among likely values of the word a subset of final values of the word, based upon the result of the second comparator.

20. In an apparatus for generating an estimated value of a word while it is being input into a machine, the value of the word to be estimated from among a plurality of likely values of the word, a generator generating a likely value of the word with the aid of a statistical model making use of the values of a predetermined number of previously entered complete words, whereby, the estimated value is related to the context of the word being input.

21. The apparatus of claim 20, wherein the statistical model is an n-gram model.

22. The apparatus of claim 20, further comprising:
a second comparator comparing the spelling of any entered portion of the word being input with the spelling of likely values; and
a second selector selecting among likely values of the word a subset of final values of the word, based upon the result of the second comparator.

23. A method for improving keyboard communication between a skilled individual and a lesser skilled individual in a language, comprising the steps of:
providing the skilled individual with means estimating completion of a keyboard entry;
determining whether an estimated completion selected by the skilled individual is in a vocabulary known by the lesser skilled individual;
if the result of the determining step is in the affirmative, inserting the selected completion in a communication with the lesser skilled individual;
if the result of the determining step is negative, suggesting to the skilled individual alternative terminology that would be understood by the lesser skilled individual; and
upon the skilled individual's selection from the alternative terminology, inserting the selected terminology in a communication with the lesser skilled individual.

24. A method of calculating a word intended to be typed by a user, said method comprising:
determining a portion of a user input;
comparing said portion with words that have a similar portion to generate a potential display list,
narrowing the display list based upon a model of words likely to be entered in response to a lesson being studied by said user at a time of said user input;
narrowing said display list based upon a set of words already studied by said user;
displaying a final display list.

25. A method a teaching language to a language learner, the method comprising:
maintaining information indicative of words already studied by said language learner;
accepting user input of a partial word:
comparing said partial word phonetically to a corresponding portion of partial words already learned by said language learner; and
suggesting one or more full words intended, said suggesting being based at least in part upon said partial word and said words already learned.

26. The method of claim 25 wherein said suggesting is further based upon a present language lesson being executed.

27. The method of claim 1 wherein said likely values are determined based at least upon lesson being executed.

28. The method of claim 1 wherein said likely values are determined based at least upon meaning of said intended full word.

29. A method of facilitating communications between two users comprising:
maintaining a record indicative of a level of skill associated with a first user;
monitoring communications from a second user in a first language;
if said communications from said second user are at or below a level of skill in said first language associated with said first user, passing said communications to said first user, and
if not, translating said communications to a level at or below said level of skill, but maintaining said communications in said first language.

30. The method of claim 29 wherein said communications are verbal.

31. The method of claim 30 wherein said communications are textual.

32. A method comprising analyzing a first message entered by a first user, determining whether said first message is understandable to a second user based at least in part upon said first message and a level of knowledge of said second user, if not, translating said first message into a second message, said first and second messaged being in the same language.

33. The method of claim 32 wherein said first message is a single word.

34. The method of claim 32 wherein said first message is plural words.
